(19) United States
(12) Patent Application Publication
(10) Pub. No.: US 2021/0293494 A1
(43) Pub. Date: Sep. 23, 2021

(54) Wedge Tool For Radiator Assembly Process

(71) Applicant: DENSO International America, Inc., Southfield, MI (US)

(72) Inventor: Mario ZERON HERNANDEZ, Royal Oak, MI (US)

(21) Appl. No.: 16/824,162

(22) Filed: Mar. 19, 2020

(51) Int. Cl. F28F 9/02; F01P 11/08

(52) U.S. Cl. CPC F28F 9/0234; F28D 9/0043; F01P 2060/04; F01P 11/08

(57) ABSTRACT

An assembly wedge for an oil cooler in a radiator tank includes a housing and a biased pin. The biased pin is disposed slideably within the housing and is configured to engage the oil cooler.

### FIELD

The present disclosure relates to an assembly process for a radiator tank, and, more specifically, a wedge tool used in the assembly process of the radiator tank.

### BACKGROUND

This section provides background information related to the present disclosure which is not necessarily prior art.

Radiators utilize in-tank cooler assemblies to cool liquid flowing therethrough. During radiator tank assembly, the various sized in-tank coolers are installed in the radiator tank. During the installation process, wedges of different thicknesses are used to load different size oil coolers into the radiator tank. A selected wedge from the wedges of different thicknesses is used to bias the oil cooler against an installation surface of the radiator tank while fasteners are used to fix the oil cooler against the installation surface.

### SUMMARY

This section provides a general summary of the disclosure, and is not a comprehensive disclosure of its full scope or all of its features.

At least one example embodiment of an assembly wedge for an oil cooler in a radiator tank according to the present disclosure includes a housing and a biased pin. The biased pin is disposed slideably within the housing and is configured to engage the oil cooler.

In at least one example embodiment, a handle may be fixed to a top surface of the housing.

In at least one example embodiment, the housing may include a pair of arms connected by a base. The biased pin may be disposed slideably within an arm of the pair of arms.

In at least one example embodiment, the biased pin may include a rod, a head, and a biasing member.

In at least one example embodiment, the biasing member may be a spring.

In at least one example embodiment, the biasing member may be a helical spring.

In at least one example embodiment, the biasing member may engage the head of the pin and a top surface of the housing.

In at least one example embodiment, the housing may include a pair of arms connected by a base.

In at least one example embodiment, the biased pin may be one of a pair of biased pins. Each of the pair of biased pins may be slideably disposed within one of the pair of arms.

In at least one example embodiment, each of the pair of biased pins may be disposed in a free end of one of the pair of arms. The free end may be opposite the base.

At least one example embodiment of a method of assembling an oil cooler in a radiator tank according to the present disclosure includes aligning the oil cooler in the radiator tank; engaging a head of a biased pin with the oil cooler to bias the oil cooler into engagement with an inside surface of the radiator tank; fastening the oil cooler to the radiator tank; and removing the biased pin from the radiator tank.

In at least one example embodiment, the method may include inserting a wedge having the biased pin into the radiator tank between the oil cooler and a wall of the radiator tank.

In at least one example embodiment, the wedge may include a housing, and the biased pin man be slideably disposed in the housing.

In at least one example embodiment, inserting the wedge into the radiator tank may include inserting a pair of arms of the housing of the wedge into the radiator tank.

In at least one example embodiment, engaging a head of a biased pin with the oil cooler may include engaging a pair of the biased pins. Each of the pair of the biased pins may be slideably disposed within one of the pair of arms.

In at least one example embodiment, each of the pair of the biased pins may be disposed in a free end of one of the pair of arms. The free end may be opposite the base.

In at least one example embodiment, the engaging the head of the biased pin with the oil cooler may include compressing a biasing member on the pin and sliding the pin within a housing in a compressed state.

In at least one example embodiment, the biasing member may be a spring.

In at least one example embodiment, the biasing member may be a helical spring.

In at least one example embodiment, the removing the biased pin from the radiator tank may include decompressing a biasing member on the pin and sliding the pin out of a housing in a decompressed state.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of a radiator assembled using the oil cooler assembly wedge of the present disclosure.

FIG. 2 is a side view of an oil cooler assembled in a radiator tank using the oil cooler assembly wedge of the present disclosure.

FIG. 3 is a top view of an oil cooler assembly wedge according to the present disclosure.

FIG. 4 is a side view of the oil cooler assembly wedge of FIG. 3.

FIG. 5 is a side view of a pin of the oil cooler assembly wedge of FIG. 3 in an unloaded state.

FIG. 6 is a side view of the pin of the oil cooler assembly wedge of FIG. 5 in a loaded state.

FIG. 7 is a side view of an assembly process for a first oil cooler in the radiator tank using the oil cooler assembly wedge of the present disclosure.

FIG. 8 is a side view of an assembly process for a second oil cooler in the radiator tank using the oil cooler assembly wedge of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

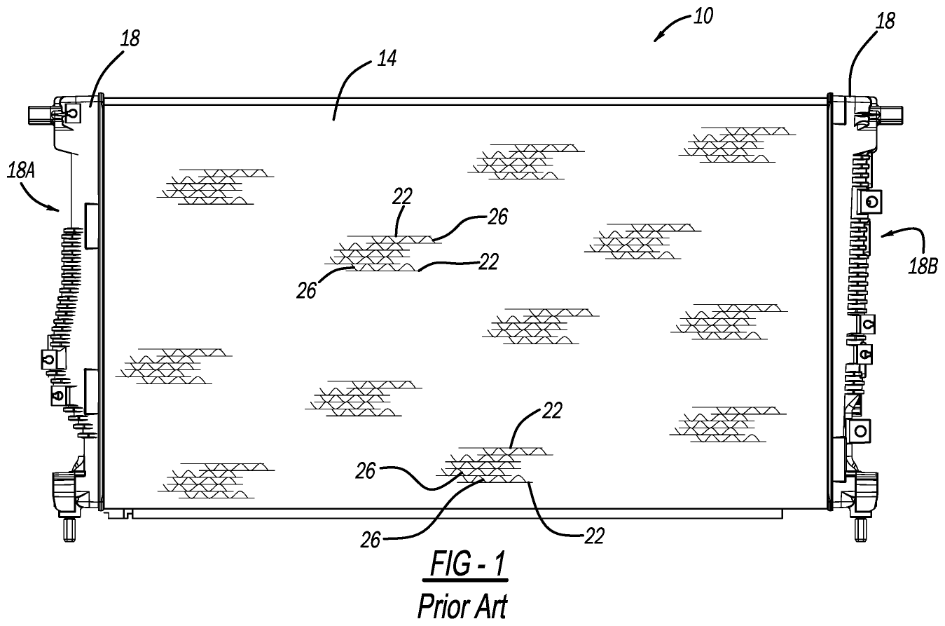

Referring to FIG. 1, at least one example embodiment of a radiator 10 according to the present disclosure is illustrated. The radiator 10 includes a core 14 and at least one end tank (e.g., inlet tank 18A and outlet tank 18B), plastic tank, or p-tank, 18. In at least one example embodiment, a pair of p-tanks 18 may be disposed on opposing ends of the core 14, sandwiching the core 14 therebetween.

In at least one example embodiment, the core 14 includes rows of tubes 22 extending from one p-tank 18 (such as inlet tank 18A) to a second p-tank 18 (such as outlet tank 18B). The rows of tubes are separated by fins 26 that are lodged between each row of tubes. During use, a liquid, such as coolant or oil, travels from the inlet tank 18A to the outlet tank 18B through the tubes. Heat is transferred from the liquid to the atmosphere through the fins separating each row of tubes.

The p-tanks 18 on the ends of the core 14 hold coolant that is distributed into and out of the core 14. The p-tank 18 may also be known as the coolant reservoir, or overflow canister. As the engine heats up, the coolant inside the engine expands. Without the p-tank 18, the coolant would flow out of the overflow in the engine to be lost from the cooling system onto the street. Instead, the coolant flows into the p-tank 18 (specifically inlet tank 18A) and into the core 14 for cooling.

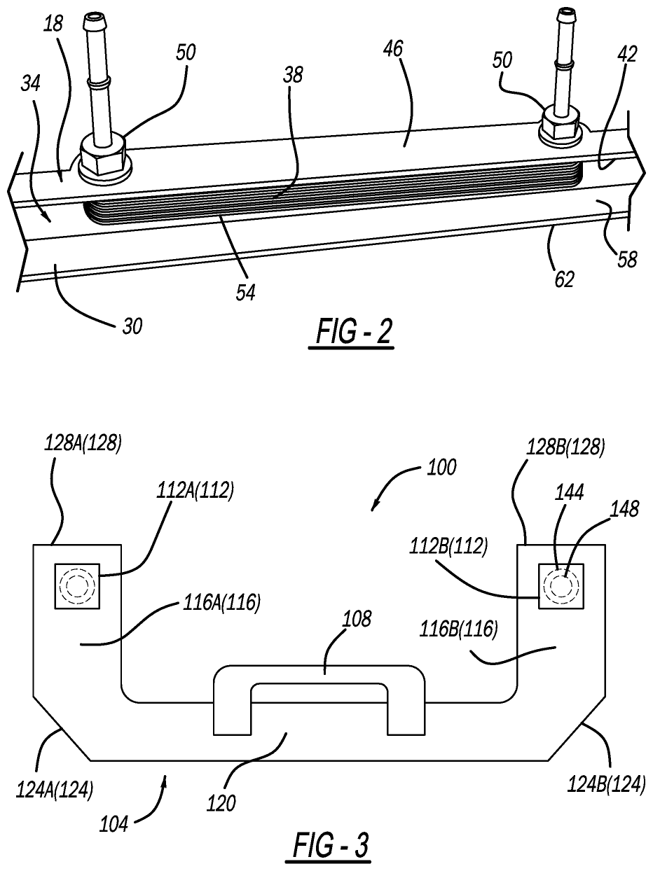

Referring additionally to FIG. 2, the p-tank 18 may include a housing 30 formed of a plastic, or other polymer, a metal, or another appropriate material. At least one example embodiment, the p-tank 18 may be formed by injection molding, metal rolling or stamping, etc., to create a single, monolithic part.

In at least one example embodiment, the housing 30 of the p-tank 18 may be a hollow structure defining a cavity 34 therein. The p-tank 18 may house and support an oil cooler 38 within the cavity 34 to extract heat from the liquid retained in the cavity 34.

The oil cooler 38 may operate like a radiator within the radiator 10 to cool the liquid. However, instead of exchanging heat with the air (similar to the tube and fin structure in the core 14), the oil cooler 38 exchanges heat with the liquid in the p-tank 18.

In at least one example embodiment, the oil cooler 38 may be fixed on an interior surface 42 of a wall 46 of the housing 30 by fixtures 50. For example only, screws, bolts, or other fixtures may extend through the wall 46 of the housing 30 and attach the oil cooler 38 to the interior surface 42.

During assembly of the oil cooler 38 in the housing 30, a wedge is selected from a variety of wedges having different thicknesses. The wedge is inserted between a bottom surface 54 of the oil cooler 38 and an interior surface 58 of a wall 62 opposing the wall 46 on which the oil cooler 38 is fixed. Because oil coolers 38 come in varying thicknesses, it was previously necessary for an installer to have a variety of wedges having different thicknesses for installing the variety of oil coolers 38 in p-tanks 18.

Now referring to FIG. 3, a top view of an oil cooler assembly wedge 100 according to the present disclosure is illustrated. The assembly wedge 100 includes a housing 104, a handle 108, and at least one pin 112. The housing 104 may be a U-shaped housing having a pair of arms 116 (116A, 116B) connected by a base 120. The housing 104 may have angular exterior corners 124 (124A, 124B) at opposing ends of the base 120.

In at least one example embodiment, the at least one pin 112 may be two pins 112A, 112B, with one pin 112 disposed at a free end 128 (128A, 128B) of each arm 116A, 116B.

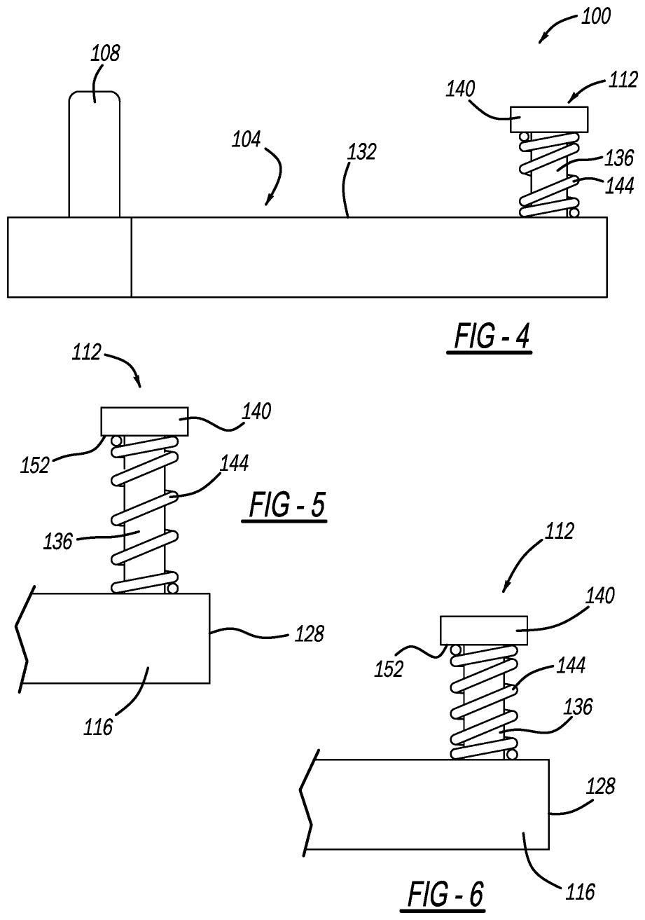

Now referring additionally to FIG. 4, the housing 104 may have a square- or rectangular-shaped cross-section and may be tubular to save weight and material costs. In at least one example embodiment, the housing 104 may have a consistent thickness along each arm 116 or may have a consistent thickness throughout the housing 104. The housing 104 may be manufactured as a single, monolithic part, having the same material used throughout. For example only, the housing 104 may be manufactured of a metal (such as steel, aluminum, any other appropriate metal, or a combination thereof), a ceramic, or a polymer (such as plastic, etc.). The housing 104 may be formed by rolling, bending, welding, extruding, casting, injection molding, blow molding, or any other appropriate process.

In at least one example embodiment, the handle 108 may be a U-shaped handle fixed to a top surface 132 of the housing 104, and, more specifically, to the top surface 132 of the base 120 of the housing 104. The handle 108 may be pivotably fixed, such as with a hinge, for example. Alternatively, the handle 108 may be immovably fixed. In at least one example embodiment, the handle may be a cylindrical or tubular handle. The handle 108 may be manufactured as a single, monolithic part, having the same material used throughout. For example only, the handle 108 may be manufactured of a metal (such as steel, aluminum, any other appropriate metal, or a combination thereof), a ceramic, or a polymer (such as plastic, etc.). The handle 108 may be formed by rolling, bending, welding, extruding, casting, injection molding, blow molding, or any other appropriate process.

In at least one example embodiment, each of the at least one pin 112 may include a cylindrical rod 136, a head 140, and a biasing member 144. For example, the pin 112 may be a spring loaded pin. In at least one example embodiment, the rod 136 may be slideably received within an aperture 148 in the housing 104. More specifically, the aperture 148 may be disposed in the free end 128 of the arm 116.

Referring additionally to FIGS. 5 and 6, the biasing member 144 may be a spring, such as a helical spring, or any other member that biases the pin 112 out of the aperture 148 and away from the top surface 132. The biasing member 144 may be coiled or wrapped around the rod 136 and may contact a bottom surface 152 of the head 140 and the top surface 132 of the housing 104.

In use, the biasing member may move between a compressed state and a decompressed state. When in the decompressed state, the biasing member 144 may be in an unloaded position as shown in FIG. 5 and the biasing member 144 may freely slide on the rod 136. In the compressed state, as shown in FIG. 6, the head 140 of the pin 112 is pressed with a force overcoming a biasing force of the biasing member 144 and the rod 136 is moved into the aperture 148 and the head 140 of the pin 112 moves toward the top surface 132 of the housing 104. When compressed, the biasing member 144 may apply force to bias, or separate, the head 140 of the pin 112 away from the housing 104 and the rod 136 out of the aperture 148. In at least one example embodiment, the greater the biasing member 144 is compressed, the greater the force applied to bias or separate the head 140 of the pin 112 away from the housing 104.

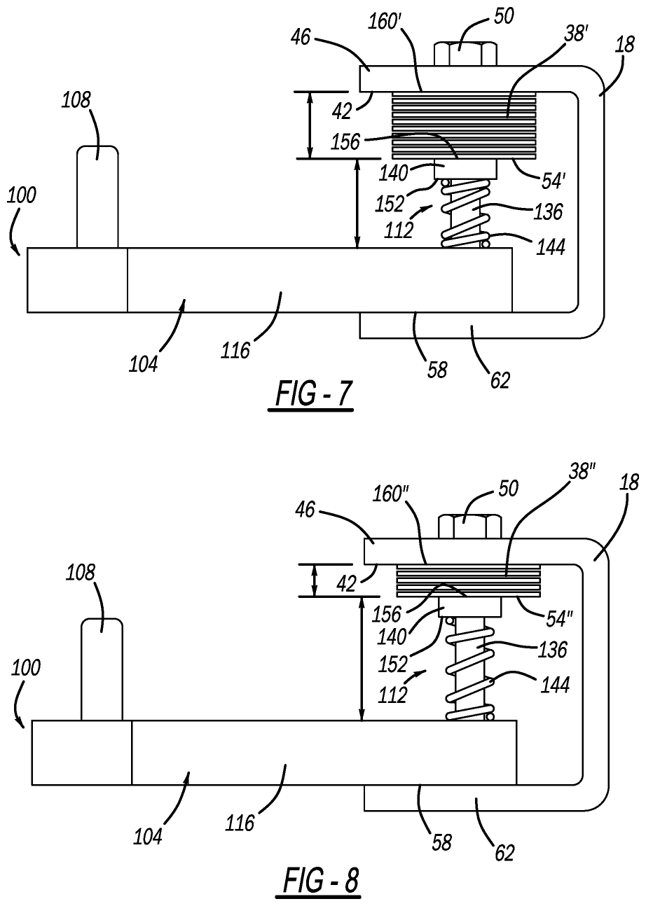

Now referring to FIGS. 7 and 8, the wedge 100 may be used to assemble various oil coolers 38 within the p-tank 18. Oil coolers 38 may be provided having varying thicknesses. The pin 112 in the housing 104 allows the wedge 100 to be used to install oil coolers 38 having varying thicknesses into the p-tank 18, thus eliminating the need for multiple wedges 100 of multiple thicknesses.

As shown in FIG. 7, the wedge 100 may be used during the installation of a thick oil cooler 38′ in the p-tank 18. When the oil cooler 38′ is installed in the p-tank 18, the oil cooler 38′ is brought into engagement with the interior surface 42 of the wall 46 of the p-tank 18 and apertures on opposing ends of the oil cooler 38′ are aligned with apertures in the wall 46 of the p-tank 18. The wedge 100 is inserted between the bottom surface 54′ of the oil cooler 38′ and an interior surface 58 of a wall 62 opposing the wall 46 on which the oil cooler 38 is aligned to be fixed. A top surface 156 of the head 140 of the pin 112 may be engaged with the bottom surface 54′ of the oil cooler 38′.

In at least one example embodiment, the biasing member 144 may be compressed. In the compressed state, the biasing member 144 may bias the head 140 of the pin 112 into the bottom surface 54′ of the oil cooler 38′. A force exerted by the biasing member 144 is sufficient to support the oil cooler 38′ and engage a top surface 160′ of the oil cooler 38′ with the interior surface 42 of the wall 46 on the p-tank 18. When the top surface 160′ of the oil cooler 38′ is engaged with the interior surface 42 of the wall 46 on the p-tank 18, the fasteners 50 are inserted into the apertures on opposing ends of the oil cooler 38′ which are aligned with the apertures in the p-tank 18.

Once the fasteners 50 are fastened within the apertures on the oil cooler 38′ and the p-tank 18, the wedge 100 is removed from the assembly and the biasing member 144 returns from the compressed state to the decompressed state (i.e., FIG. 5).

As shown in FIG. 8, the wedge 100 may be used during the installation of a thin oil cooler 38″ in the p-tank 18. When the oil cooler 38″ is installed in the p-tank 18, the oil cooler 38″ is brought into engagement with the interior surface 42 of the wall 46 of the p-tank 18 and apertures on opposing ends of the oil cooler 38″ are aligned with apertures in the p-tank 18. The wedge 100 is inserted between the bottom surface 54″ of the oil cooler 38″ and an interior surface 58 of a wall 62 opposing the wall 46 on which the oil cooler 38 is aligned to be fixed. A top surface 156 of the head 140 of the pin 112 may be engaged with the bottom surface 54″ of the oil cooler 38″.

In at least one example embodiment, the biasing member 144 may compressed. In the compressed state, the biasing member 144 may bias the head 140 of the pin 112 into the bottom surface 54″ of the oil cooler 38″. When compared with the oil cooler 38′ in FIG. 7, it is noted that the biasing member 144 is compressed less with the oil cooler 38″ in FIG. 8 than with the oil cooler 38′ in FIG. 7 (for example, because of the difference in thickness of the oil coolers 38′, 38″). A force (for example, a force less than the force exerted in FIG. 7) exerted by the biasing member 144 is sufficient to support the oil cooler 38″ and engage a top surface 160″ of the oil cooler 38″ with the interior surface 42 of the wall 46 on the p-tank 18. When the top surface 160″ of the oil cooler 38″ is engaged with the interior surface 42 of the wall 46 on the p-tank 18, the fasteners 50 are inserted into the apertures on opposing ends of the oil cooler 38″ which are aligned with the apertures in the p-tank 18.

Once the fasteners 50 are fastened within the apertures on the oil cooler 38″ and the p-tank 18, the wedge 100 is removed from the assembly and the biasing member 144 returns from the compressed state to the decompressed state (i.e., FIG. 5).

As FIGS. 7 and 8 illustrate, the wedge 100 may be used to install varying thicknesses of oil coolers 38, 38′, 38″ in the p-tank 18 because of the flexibility in compression of the pin 112 and biasing member 144. Accordingly, sets of multiple wedges are no longer necessary during the assembly processes of p-tanks, reducing the cost of labor and tools.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly wedge for an oil cooler in a radiator tank, the assembly wedge comprising:
a housing; and
a biased pin disposed slideably within the housing and configured to engage the oil cooler.

2. The assembly wedge of claim 1, further comprising a handle fixed to a top surface of the housing.

3. The assembly wedge of claim 1, wherein the housing includes a pair of arms connected by a base, the biased pin being disposed slideably within an arm of the pair of arms.

4. The assembly wedge of claim 1, wherein the biased pin includes a rod, a head, and a biasing member.

5. The assembly wedge of claim 4, wherein the biasing member is a spring.

6. The assembly wedge of claim 5, wherein the biasing member is a helical spring.

7. The assembly wedge of claim 4, wherein the biasing member engages the head of the pin and a top surface of the housing.

8. The assembly wedge of claim 1, wherein the housing includes a pair of arms connected by a base.

9. The assembly wedge of claim 8, wherein the biased pin is one of a pair of biased pins, each of the pair of biased pins being slideably disposed within one of the pair of arms.

10. The assembly wedge of claim 9, wherein each of the pair of biased pins is disposed in a free end of one of the pair of arms, the free end being opposite the base.

11. A method of assembling an oil cooler in a radiator tank comprising:
aligning the oil cooler in the radiator tank;
engaging a head of a biased pin with the oil cooler to bias the oil cooler into engagement with an inside surface of the radiator tank;
fastening the oil cooler to the radiator tank; and
removing the biased pin from the radiator tank.

12. The method of claim 11, further comprising inserting a wedge having the biased pin into the radiator tank between the oil cooler and a wall of the radiator tank.

13. The method of claim 12, wherein the wedge includes a housing and the biased pin is slideably disposed in the housing.

14. The method of claim 13, wherein inserting the wedge into the radiator tank includes inserting a pair of arms of the housing of the wedge into the radiator tank.

15. The method of claim 14, wherein engaging a head of a biased pin with the oil cooler includes engaging a pair of the biased pins, each of the pair of the biased pins being slideably disposed within one of the pair of arms.

16. The method of claim 15, wherein each of the pair of the biased pins is disposed in a free end of one of the pair of arms, the free end being opposite the base.

17. The method of claim 11, wherein the engaging the head of the biased pin with the oil cooler includes compressing a biasing member on the pin and sliding the pin within a housing in a compressed state.

18. The method of claim 17, wherein the biasing member is a spring.

19. The method of claim 17, wherein the biasing member is a helical spring.

20. The method of claim 11, wherein the removing the biased pin from the radiator tank includes decompressing a biasing member on the pin and sliding the pin out of a housing in a decompressed state.
